(19) United States
(12) Patent Application Publication
(10) Pub. No.: US 2009/0217887 A1
(43) Pub. Date: Sep. 3, 2009

(54) HORSE CALMING DEVICE

(76) Inventor: Adrian Morgante, Queensland (AU)

Correspondence Address: KLEIN, O'NEILL & SINGH, LLP, 43 CORPORATE PARK, SUITE 204, IRVINE, CA, 92606, US

(21) Appl. No.: 12/278,045

(22) PCT Filed: Jan. 31, 2007
(86) PCT No.: PCT/AU2007/000084

§ 371 Date: Nov. 5, 2008

(30) Foreign Application Priority Data
Feb. 1, 2006 (AU) 2006900467

(51) Int. Cl. B68B 1/00; B68B 1/13; B68B 5/00

(52) U.S. Cl. 119/850; 54/11

(57) ABSTRACT

A device for calming a horse includes a cover. The cover is configured to be mounted on a horse's head so that the cover at least limits the horse's central, side and upper vision and allows the horse to view its front hooves relative to the ground.

### TECHNICAL FIELD

The present invention relates to a device for calming a horse. The present invention has particular, although not exclusive application to horses that are required to be transported and horses prior to competing, such as racehorses and show jumpers.

### BACKGROUND

As is well-known, loading horses into a float or other transport arrangement can be both dangerous and difficult. Many horses baulk at approaching such devices, especially where they are associated with previous bad experiences. Often the horse will rear and back out causing injury to person and horse alike.

Another example of a dangerous situation is that which arises when attempting to load a racehorse into a starting gate prior to a race. Racehorses are generally quite temperamental and invariably become difficult to handle in that situation. Blinkers or blinders can be used to make a horse more tractable during a race by limiting the horse's peripheral vision. However, these devices are not effective in lowering stress levels when handling horses or loading them into a starting gate. When loading into a starting gate, the horse, handler and the jockey can be seriously injured. At the least, the horse and the jockey can become stressed resulting in a poor performance during the race. Given the large amounts of money associated with the outcomes of such races, it is highly undesirable that both horse and rider be even slightly distracted.

### SUMMARY OF THE INVENTION

According to a first aspect of the invention, there is provided a device for calming a horse, the device including
a cover, the cover being configured to be mounted on a horse's head so that the cover at least limits the horse's central, side and upper vision and allows the horse to view its front hooves relative to the ground.

It is thus an advantage of the present invention to provide a device for calming horses, particularly prior to competing or transport. The horse is calmed since its view of a feared object such as a starting gate or float is restricted.

The cover may include a vision limiter that is shaped so that when the cover is mounted on the horse's head, the limiter serves to at least limit the central, side and upper vision. The limiter may further be shaped so that a gap is defined between sides of the limiter and the horse's head to allow the horse the view its front hooves relative to the ground.

An image may be arranged on an inner surface of the vision limiter so that the image is visible to the horse when the cover is mounted on the horse's head.

The cover may include a lighting assembly mounted with respect to the vision limiter to light the image and enhance its visibility to the horse. The lighting assembly may include at least one light emitting diode (LED) mounted on the inner surface of the vision limiter and a power supply connected to the, or each, LED.

The cover may include a fastening arrangement that is engageable with at least the horse's head to fasten the vision limiter to the horse's head in a releasable manner. The fastening arrangement may be in the form of at least one strap for strapping the vision limiter to the horse's head. The fastening arrangement may include a muzzle strap for passing beneath the horse's muzzle to strap the vision limiter to the horse's muzzle. The fastening arrangement may include a lateral strap for passing around the horse's head behind the horse's ears. The fastening arrangement may include a top strap that is fastenable between the vision limiter and the lateral strap such that it passes between the ears of the horse.

The, or each, strap may be fixed at one end to the vision limiter while an opposite end carries a releasable fastening means.

The cover may include a handle to facilitate removal and replacement of the cover.

According to a second aspect of the invention, there is provided a method of calming a horse, the method including the step of mounting the device described above on a horse's head so that the cover limits the horse's central, side and upper vision and allows the horse to view its front hooves relative to the ground.

According to a third aspect of the invention, there is provided a device for calming a horse, the device including
a vision limiter that is mountable on a horse's head, the vision limiter being shaped and dimensioned so that when mounted on the horse's head, the vision limiter at least limits the horse's central, side and upper vision and allows the horse to view its front hooves relative to the ground; and
a fastening arrangement for fastening the vision limiter to the horse's head in a releasable manner.

According to a fourth aspect of the present invention, there is provided a device for calming a horse, the device being mountable on a horse's head and including a vision limiter for limiting the horse's central, side and upper peripheral vision, when mounted, and for allowing the horse to view its front hooves and/or the ground, to calm the horse. The vision limiter prevents the horse from viewing feared objects ahead such as floats, trailers or barrier stalls. In addition, the horse can see the ground and can still walk forward into the barrier stalls or on to a trailer or float.

Preferably, the limiter is opaque.

The limiter may include a front panel that is positioned in front of the horse's eyes when the device is mounted. The front panel may define a recess for engaging with the muzzle of the horse. The front panel may carry an image for the horse to view. The image may be a photograph of a tranquil image such as, for example, blue skies or green pastures. This creates an illusion whereby the horse thinks he/she is walking into a paddock or other desirable area and not towards a feared object. The device may further include a light for illuminating the image.

The limiter may include a pair of side panels located on either side of the front panel for engaging with the horse's head. Each side panel may be fast with the front panel.

The limiter may include a roof panel for limiting the horse's upper peripheral vision. The device may include a handle which is fast with the roof to facilitate manipulation of the device.

The device may further include fastening means for fastening the limiter to the horse's head. The fastening means may include one or more straps for strapping the limiter to the horse's head. The one or more straps may include a muzzle strap for passing beneath the horse's muzzle thereby to strap the limiter to the horse's muzzle. The one or more straps may include a lateral strap for passing around the horse's head behind the horse's ears. The device may further include an arm for fastening between the lateral strap and a roof of the limiter to impede the limiter from slipping forward along the horse's muzzle.

Each strap may be releasably fastenable to the limiter using a hook-and-loop fastening arrangement. Alternatively, each strap may be permanently fixed to the limiter and may include a resiliently extensible band.

According to a fifth aspect of the present invention, there is provided a headdress for a horse, the headdress including a vision limiter for limiting the horse's central vision.

According to a sixth aspect of the invention, there is provided a method for calming a horse, the method including the step of:
limiting the horse's central vision to thereby calm the horse.

The step of limiting may involve displaying an image for the horse to view. This step may include displaying a tranquil image.

The method may further involve the step of fastening a limiter to the horse's head. The step of fastening may involve strapping the limiter to the horse's head.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a side view of a device, in accordance with an embodiment of the present invention, for calming a horse, shown mounted on a horse's head.

FIG. 2 is an inner rear view of a vision limiter of the device.

FIG. 3 is a front view of the device.

FIG. 4 is a rear perspective view of the device.

FIG. 5 is a top perspective view of the device.

FIG. 6 is a plan view of a vision limiter for a device, in accordance with another embodiment of the present invention, for calming a horse, the vision limiter being in its unassembled state.

FIG. 7 is a side view of the device fastened to the head of a horse.

FIG. 8 is a rear view of the device fastened to the head of a horse.

FIG. 9 is a front end view of the device fastened to the head of a horse.

### DETAILED DESCRIPTION OF PREFERRED EMBODIMENTS

In the drawings, reference numeral 10 generally indicates a device, in accordance with an embodiment of the invention, for calming a horse.

The device 10 includes a cover 12 that is configured to be mounted on a horse's head 14 so that the cover 12 limits the horse's central, side and upper vision.

The cover 12 includes a vision limiter 16 that is shaped and dimensioned so that when the cover 12 is mounted on the horse's head 14, the limiter 16 serves to block the horse's central, side and upper vision. In particular, the vision limiter 16 is shaped to curve around a muzzle 18 and frontal portion 20 of the head 14. The vision limiter 16 is also shaped so that a gap 22 is defined between sides 24 of the limiter 16 and the head 14 including part of the muzzle 18.

The vision limiter 16 is shaped so the horse can see through the gap 22 to view its front hooves relative to the ground. Thus, when the cover 12 is mounted on the head 14, the horse is able to orient itself correctly. This provides a sense of security to the horse.

An image 26 is arranged on an inner surface of the limiter 16. The image 26 can be selected to be one which would provide a calming influence to the horse. For example, the image 26 can be of an area familiar to the horse. Instead, for the purposes of training, the image 26 can be of an area which usually causes anxiety, such as a horse float or starting gate.

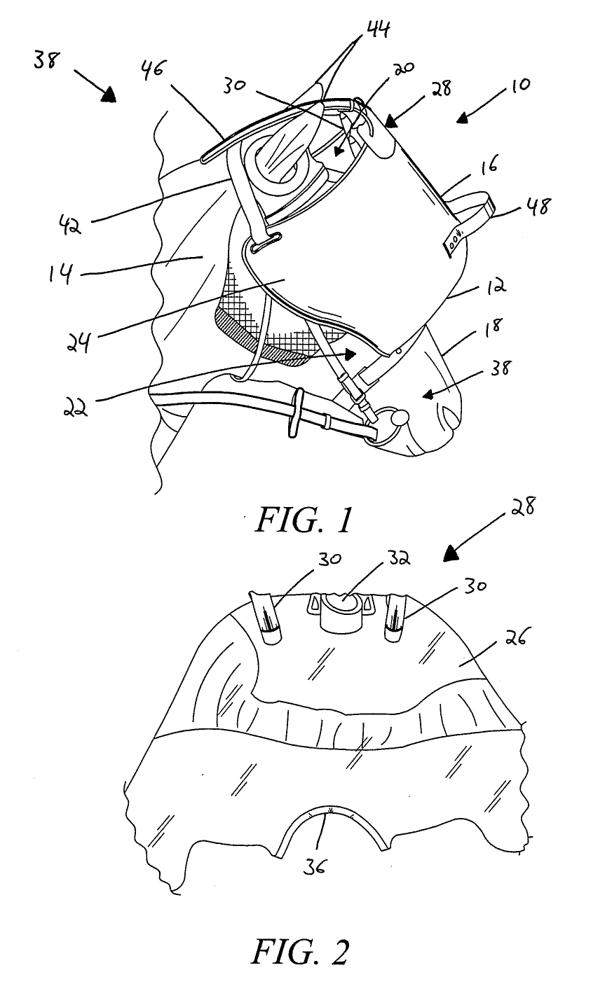

As can be seen in FIGS. 1 and 2, a lighting assembly 28 is mounted on the vision limiter 16 to illuminate the image 26. The lighting assembly 28 includes a pair of light emitting diode (LED) devices 30 directed onto the image. Applicant has found that this arrangement imparts a visual depth to the image, thereby enhancing its reality as far as the horse is concerned.

An LED power supply 32 (FIG. 2) is mounted on the limiter 16, between the LED devices 30.

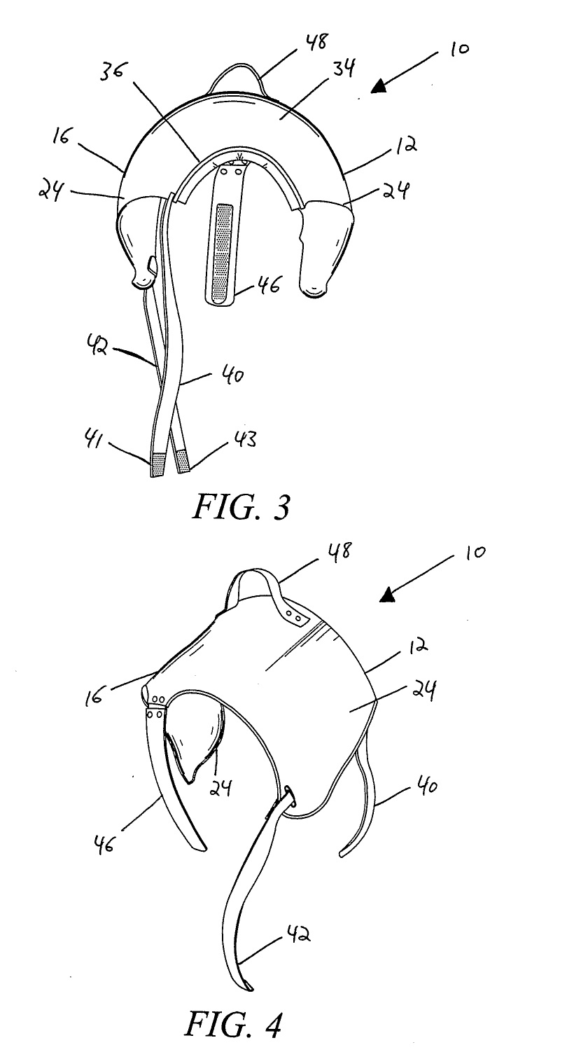

The vision limiter 16 has a frontal panel 34 (FIG. 3) that terminates in a muzzle band 36 that rests on the horse's muzzle 18.

The cover 12 includes a fastening arrangement 38 for fastening the limiter 16 to the horse's head 14.

The fastening arrangement 38 includes a muzzle strap 40 with one end fastened to one side of the muzzle band 36 and the other end being fastenable, in a releasable manner, to the other side of the muzzle band 36. For that purpose, said other side of the muzzle band 36 and said other end of the muzzle strap 40 have complementary sections 41 of a hook-and-loop fastener, known as Velcro™. Thus, when the cover 12 is in position, the muzzle strap 40 is passed around the muzzle 18 to fasten the cover 12 in position.

The fastening arrangement 38 includes a lateral strap 42. One end of the lateral strap 42 is fast with one of the sides 24 of the vision limiter 16. The other end of the lateral strap 42 and the other side 24 of the limiter 16 have complementary sections 43 of a hook-and-loop fastener, known as Velcro™. Thus, when the cover 12 is in position, the lateral strap 42 is passed behind the horse's ears 44 and fastened to the limiter 16 further to fasten the cover 12 in position.

The fastening arrangement 38 includes a top strap 46. One end of the top strap 46 is fast with the vision limiter 16. The other end of the top strap 46 and a portion of the lateral strap 42, intermediate its ends, have complementary sections 45 of a hook-and-loop fastener, known as Velcro™. Thus, when the cover 12 is in position, the top strap 42 is passed between the horse's ears 44 and fastened to the lateral strap 42 further to fasten the cover 12 in position.

The cover 12 includes a handle 48 positioned so that a person can readily remove and replace the cover 12. The handle 48 is particularly useful for removing the cover 12 once the horse is in a starting gate, for example, before a race.

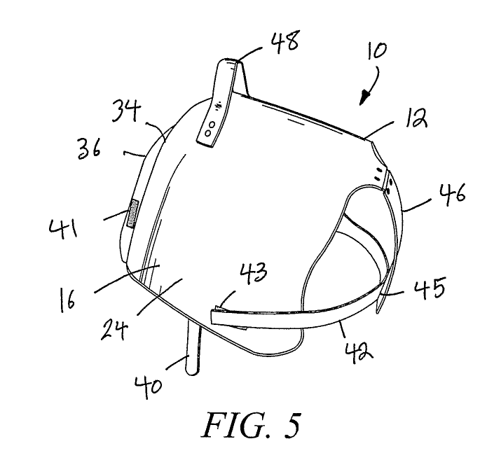

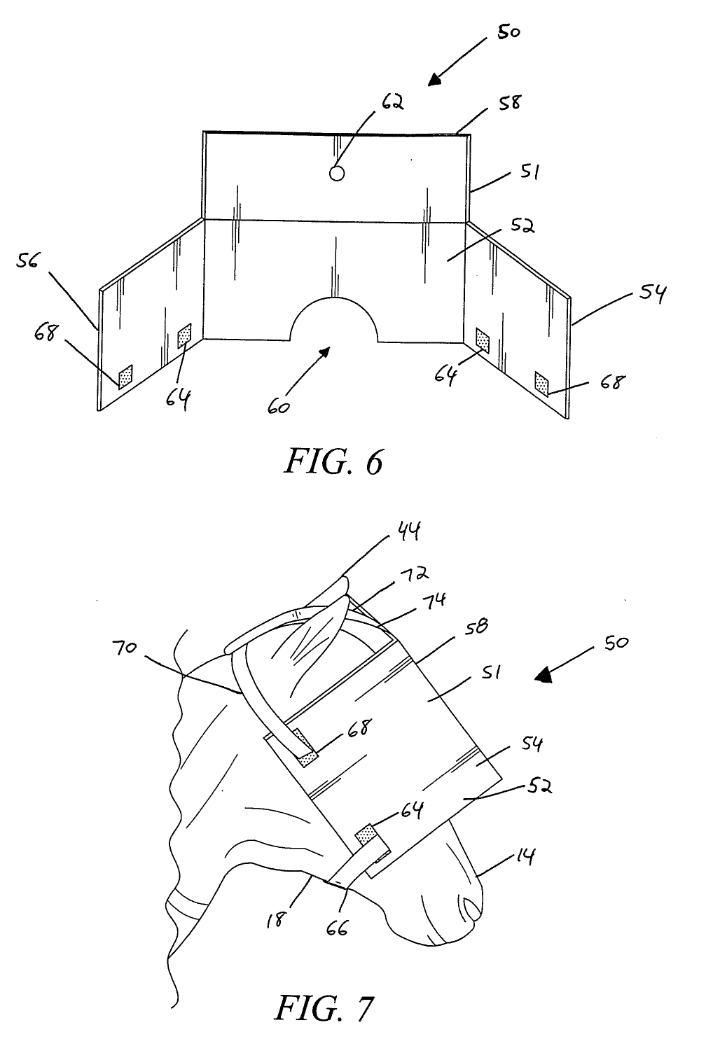

In FIGS. 6 to 9, reference numeral 50 generally indicates a device, in accordance with another embodiment of the invention, for calming a horse. With reference to FIGS. 1 to 5, like reference numerals refer to like parts, unless otherwise specified.

The device 50 has a vision limiter 51. In FIG. 6, the vision limiter 51 is in a substantially planar and unassembled state. The limiter 51 includes a screen 52 for limiting the horse's central vision and a pair of lateral visors 54, 56 which each extend from a respective side of the screen 52 to limit the horse's side peripheral vision. The vision limiter 51 further includes a roof 58 for limiting the horse's upper peripheral vision. The vision limiter 51 is integrally formed from opaque plastics material, and the visors 54, 56 and roof 58 can each be readily bent with respect to the screen 52. Opposite sides of the roof 58 can be fast with each lateral visor 54, 56 when assembling the vision limiter 51 for use.

In use, the screen 52 is located in register with the horse's eyes. The screen 52 defines a recess 60 at its lower edge for receiving the muzzle 18 of the horse. The screen 52 includes a removable image for the horse to view (not shown). The image may be a photograph of a tranquil setting such as, for example, a panorama with which the horse is familiar. The image may include blue skies and/or green pastures. The Applicant has found that these images have a soothing and calming effect on the horse. A light 62 for illuminating the image may be fastened to the roof 58 of the vision limiter 51.

Applicant has found that the light serves to enhance a perception of distance for the horse and is useful for viewing the photograph when the horse is in darkness, whether early in the morning or at night.

The front lower corner of each visor 54, 56 includes a muzzle strap fastener 64 to which a muzzle strap 66 can be fastened. Similarly, the rear lower portion of each visor 54, 56 includes a lateral strap fastener 68 to which a lateral strap 70 can be fastened. Each fastener 64, 68 is effectively half of a loop-and-hook fastening arrangement (e.g. Velcro™) with the other half being a complementary part which is provided at an end of the corresponding strap 66, 70.

Referring to FIG. 2, the vision limiter 51 can be fastened to the horse's head 14 as shown with the muzzle strap 66, the lateral strap 68, and a top strap 72. The muzzle strap 66 passes beneath the horse's muzzle 18 and engages with each muzzle strap fastener 64 to strap the limiter 51 to the horse's muzzle 18. The muzzle strap 66 impedes the limiter 51 from lifting from the horse's muzzle 18 in use. The lateral strap 68 extends from either side of the horse's head 14 and behind the horse's ears 44. The lateral strap 68 engages the lateral strap fasteners 68 to impede the limiter 51 from sliding down and along the horse's muzzle 26. Each strap 66, 70 may be resiliently extensible. Alternatively, each strap 66, 70 may be inextensible.

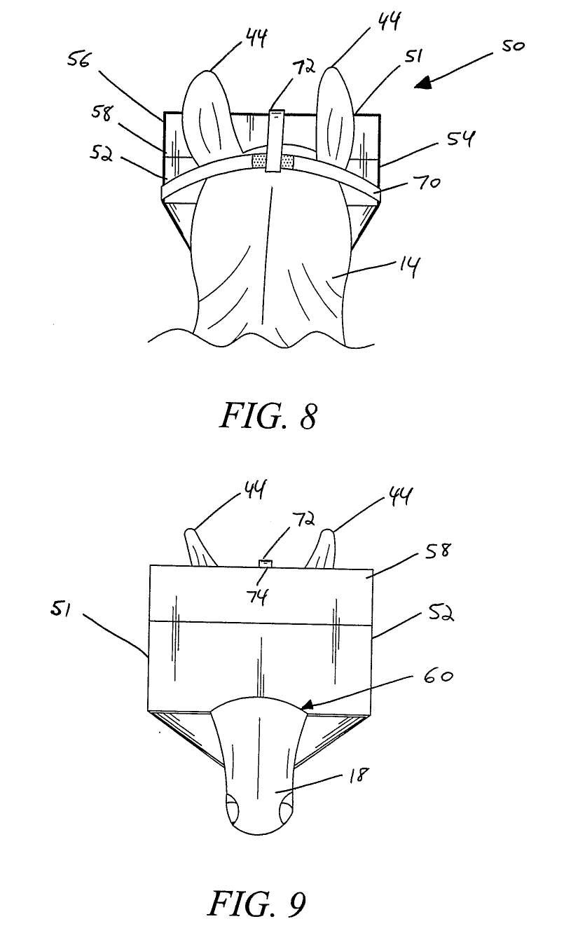

As can best be seen in FIG. 8, the lateral strap 70 includes a top strap fastener 74 for fixedly engaging with a complementary fastener (not shown) at an end of the top strap 72. The other end of the top strap 72 can be fixedly attached to the roof 58 of the limiter 51. In this manner, the top strap 72 further serves to impede the limiter 51 from slipping along the horse's muzzle 18. The top strap 72 may be fastened to the lateral strap 70 and roof 58 using a hook-and-loop fastener arrangement.

As can be seen in FIGS. 7 to 9, the horse's central (i.e. direct) vision is substantially limited by the vision limiter 51. However, the vision limiter 51 is sized so that the horse's lower peripheral (i.e. indirect) vision is not limited and so that the horse can see the ground. In this manner, the horse can be readily led by a handler whilst wearing the limiter 51. The horse remains quite calm whilst the central vision is limited and is not distracted by events in the horse's central vision. Furthermore, the tranquil photographic image provided as part of the screen 52 also serves to calm the horse.

A method for conditioning the horse to be calm around feared objects, using the limiter 16, 51 of both embodiments, is now described. The handler may take a photograph of an object which the horse fears such as the horse's float or trailer, a racing barrier, or a tractor. The photograph may be fastened to the inner surface of the limiter 16, 51 using five pieces of adhesive tape or other material (e.g. Bluetack™), whereby one piece is located at each corner of the photograph and another piece is located in the centre of the photograph. Periodically exposing the horse to this image when the horse is in safe surrounds will serve to condition the horse not to fear the object in the photograph over time. That is, the horse can be made routinely to wear the limiter 16, 51 and will become familiar with the object which, in turn, removes the horse's fear of that object.

A person skilled in the art will appreciate that many embodiments and variations can be made without departing from the ambit of the present invention.

In the preferred embodiments, the device 10, 50 is configured to be worn on the horse's head 14. In an alternative embodiment, the limiter 16, 51 can instead be fastened to a horse float or racing barrier.

Applicant believes that the device 10, 50 provides an effective manner of calming a horse, particularly prior to transportation and competition, such as horseracing. As is well known in horseracing, a difference between a win and a loss can amount to mere fractions of a second. It follows that any advantage, such as a calm horse, can make the difference between winning and losing. Given the amounts of money involved, a calm horse prior to a horserace is highly desirable.

In compliance with the statute, the invention has been described in language more or less specific to structural or methodical features. It is to be understood that the invention is not limited to specific features shown or described since the means herein described comprises preferred forms of putting the invention into effect.

1. A device for calming a horse, the device including
a cover, the cover being configured to be mounted on a horse's head so that the cover at least limits the horse's central, side and upper vision and allows the horse to view its front hooves relative to the ground.

2. A device as claimed in claim 1, in which the cover includes a vision limiter that is shaped so that when the cover is mounted on the horse's head, the limiter serves to at least limit the horse's central, side and upper vision.

3. A device as claimed in claim 2, in which an image is arranged on an inner surface of the vision limiter so that the image is visible to the horse when the cover is mounted on the horse's head.

4. A device as claimed in claim 3, in which the limiter is shaped so that a gap is defined between sides of the limiter and the horse's head to allow the horse to view its front hooves relative to the ground.

5. A device as claimed in claim 3, in which the cover includes a lighting assembly mounted with respect to the vision limiter to light the image and enhance its visibility to the horse.

6. A device as claimed in claim 3, in which the lighting assembly includes at least one light emitting diode (LED) mounted on the inner surface of the vision limiter and a power supply connected to the, or each, LED.

7. A device as claimed in claim 2, in which the cover includes a fastening arrangement that is engageable with at least the horse's head to fasten the vision limiter to the horse's head in a releasable manner.

8. A device as claimed in claim 7, in which the fastening arrangement is in the form of at least one strap for strapping the vision limiter to the horse's head.

9. A device as claimed in claim 8, in which the fastening arrangement includes a muzzle strap for passing beneath the horse's muzzle to strap the vision limiter to the horse's muzzle.

10. A device as claimed in claim 8, in which the fastening arrangement includes a lateral strap for passing around the horse's head behind the horse's ears.

11. A device as claimed in claim 10, in which the fastening arrangement includes a top strap that is fastenable between the vision limiter and the lateral strap such that it passes between the ears of the horse.

12. A device as claimed in claim 8, in which the, or each, strap is fixed at one end to the vision limiter while an opposite end carries a releasable fastening means.

13. A device as claimed in claim 1, in which the cover includes a handle to facilitate removal and replacement of the cover.

14. A method of calming a horse, the method including the step of mounting the device of claim 1 on a horse's head so that the cover limits the horse's central, side and upper vision and allows the horse to view its front hooves relative to the ground.

15. A device for calming a horse, the device including
a vision limiter that is mountable on a horse's head, the vision limiter being shaped and dimensioned so that when mounted on the horse's head, the vision limiter at least limits the horse's central, side and upper vision and allows the horse to view its front hooves relative to the ground; and
a fastening arrangement for fastening the vision limiter to the horse's head in a releasable manner.
